(19) United States
(12) Patent Application Publication
(10) Pub. No.: US 2026/0085558 A1
(43) Pub. Date: Mar. 26, 2026

(54) PUSH DOOR LOCK DEVICE

(71) Applicant: DUAL POWER ELECTRONICS CO., LTD, Jeongeup-si (KR)

(72) Inventors: Jang-Joo Lim, Seoul (KR); Sang-Won Suh, Jeongeup-si (KR); Jung Gil Lee, Jeongeup-si (KR); Hee Chang Kim, Jeongeup-si (KR)

(21) Appl. No.: 19/403,671

(22) Filed: Nov. 28, 2025

Related U.S. Application Data
(63) Continuation of application No. PCT/KR2024/003404, filed on Mar. 19, 2024.

(30) Foreign Application Priority Data
Jun. 14, 2023 (KR) 10-2023-0076204

(51) Int. Cl. E05C 19/02

(52) U.S. Cl. CPC E05C 19/024

(57) ABSTRACT

A push door lock device according to an embodiment of the present invention includes a locker that fixes a hook, has a first torsion spring installed at a first center and receives a rotational force in a first direction, and a latch that rotates about a second center attached to one side, has a second torsion spring installed and receives a rotational force in a second direction, wherein the locker includes a seating portion formed by a first ring and a second ring to which the hook is fastened, an engaging portion protruding from a lower portion of the second ring, an engaging piece having a bent shape at one end of the engaging portion, and a groove portion having a recessed shape on an outer edge, and the latch includes a first inclined surface that is an edge formed toward the locker, a second inclined surface that is an edge formed toward the locker and separated from the first inclined surface at a different height, a receiving portion in which the engaging piece is accommodated to fix the locker, and a protruding piece having a shape obliquely bent at one edge of the receiving portion.

### CROSS-REFERENCE TO RELATED APPLICATIONS

This present application is a Continuation of International Patent Application No. PCT/KR2024/003404, filed on March 19, 2024, which is based upon and claims the benefit of priority to Korean Patent Application No. 10-2023-0076204 filed on June 14, 2023. The disclosures of the above-listed applications are hereby incorporated by reference herein in their entirety.

### TECHNICAL FIELD

The present invention relates to a push door lock device, and more particularly, to a push door lock device used in home appliances such as ovens and microwave ovens.

### RELATED ART

There are various types of home appliances in our daily lives. In particular, a home appliance that is used by inserting contents, for example, a washing machine, a dryer, a dishwasher, a microwave oven, and the like, is installed with a door to block the inserted contents from the outside. A locking device that opens and closes the door is an essential part that constitutes the corresponding home appliance.

Until recently, various techniques related to a door-lock device are developed. Representative examples include Korean Patent Registration No. 10-1667916 (Door-lock apparatus for push and push) and Korean Patent Registration No. 10-1915250 (Manual door-lock device).

The door-lock apparatus for push and push relates to a door-lock device that automatically opens a door without a need for a user to open the door when an operation of a corresponding home appliance is terminated.

The door-lock apparatus for push and push includes a release button installed inside a body and configured to release a locked locker by releasing a binding force of a fastening member through a sliding operation and a driving unit configured to selectively control a door holding operation, a door locking operation, and an automatic door opening operation by a rotational operation of a rotational shaft with a cam protrusion on one side. However, the above device has the complicated overall configuration and control since the driving unit and a sensing member detect a locking or unlocking operation of the locker by detecting a position of the cam protrusion.

The manual door-lock device relates to a door-lock device that may be manually operated with a simple structure, which differs from an existing method that is electronically operated by a solenoid.

Push-and-push door lock devices used in home appliances have a complicated operation process, and malfunctions frequently occur due to excessive force applied to the torsion spring. Manual door lock devices have device stability, but are inconvenient in that the door lock is opened and closed by human operation, and irregular force is applied to the device, which also causes malfunctions.

Therefore, there is a need for a door lock device that achieves organic coupling between components and implements various functions.

### DETAILED DESCRIPTION

### TECHNICAL SUBJECT

An object of the present invention is to provide a push door lock device that can be applied to home appliances such as ovens and microwave ovens. Another object is to provide a push door lock device that has almost no device malfunctions and can be implemented in a compact size.

Another object is to provide a push door lock device with excellent durability in which the connection between components constituting the device is organic and the movement clearance of the components is not large.

### TECHNICAL SOLUTION

A push door lock device according to an embodiment of the present invention includes a locker that fixes a hook, has a first torsion spring installed at a first center and receives a rotational force in a first direction, and a latch that rotates about a second center attached to one side, has a second torsion spring installed and receives a rotational force in a second direction, wherein the locker includes a seating portion formed by a first ring and a second ring to which the hook is fastened, an engaging portion protruding from a lower portion of the second ring, an engaging piece having a bent shape at one end of the engaging portion, and a groove portion having a recessed shape on an outer edge, and the latch includes a first inclined surface that is an edge formed toward the locker, a second inclined surface that is an edge formed toward the locker and separated from the first inclined surface at a different height, a receiving portion in which the engaging piece is accommodated to fix the locker, and a protruding piece having a shape obliquely bent at one edge of the receiving portion.

In addition, the push door lock device according to an embodiment of the present invention further includes a locking lever provided with a locking flange that rotates by a motor and engages with the groove portion, and further includes a first micro switch that detects an operation of the locking lever.

In addition, the push door lock device according to an embodiment of the present invention further includes a locker lever having one end in contact with the second ring and rotating, and a second micro switch that detects a closed state of the locker by movement of the locker lever.

### EFFECT

A push door lock device according to an embodiment of the present invention can be implemented in a compact size and can be installed in various home appliances.

In addition, a stable push door lock device with fewer malfunctions is provided due to organic coupling between components.

In addition, the load acting on the device due to pushing is limited, thereby reducing the risk of device malfunction.

### BRIEF DESCRIPTION OF DRAWINGS

FIG. 1 is an internal plan view of a push door lock device according to an embodiment of the present invention.

FIG. 2 is an enlarged internal view of a push door lock device according to an embodiment of the present invention.

FIG. 3 is a plan view of a push door lock device according to an embodiment of the present invention.

FIG. 4 is an internal plan view of a push door lock device according to an embodiment of the present invention.

FIG. 5 is a state diagram at a point in time when the hook is fastened to the seating portion.

FIG. 6 is a state diagram at a point in time when the hook pushes the second ring.

FIG. 7 is a state diagram when the locker is closed.

FIG. 8 is a state diagram when closing of the locker is completed.

FIG. 9 is a state diagram when the locker starts to separate from the latch.

FIG. 10 is a state diagram when separation of the locker and the latch is completed.

### MODE

Specific structural or functional descriptions of embodiments according to the concept of the present invention disclosed in this specification are merely illustrated for the purpose of explaining embodiments according to the concept of the present invention, and embodiments according to the concept of the present invention may be implemented in various forms and are not limited to the embodiments described in this specification.

Since embodiments according to the concept of the present invention can have various modifications and various forms, the embodiments are illustrated in the drawings and will be described in detail in this specification. However, this is not intended to limit the embodiments according to the concept of the present invention to specific disclosed forms, and includes all modifications, equivalents, or substitutes included in the spirit and technical scope of the present invention.

Terms such as first or second may be used to describe various components, but the components should not be limited by the terms. The terms are only for the purpose of distinguishing one component from another component, for example, without departing from the scope of rights according to the concept of the present invention, a first component may be referred to as a second component, and similarly, a second component may also be referred to as a first component.

When a component is referred to as being "connected" or "coupled" to another component, it may be directly connected or coupled to the other component, but it should be understood that other components may exist in between. On the other hand, when a component is referred to as being "directly connected" or "directly coupled" to another component, it should be understood that no other components exist in between. Other expressions describing relationships between components, such as "between" and "directly between" or "adjacent to" and "directly adjacent to," should be interpreted in the same manner.

The terminology used in this specification is only used to describe specific embodiments and is not intended to limit the present invention. Singular expressions include plural expressions unless the context clearly indicates otherwise. In this specification, terms such as "comprise" or "have" are intended to designate the presence of features, numbers, steps, operations, components, parts, or combinations thereof described in this specification, and it should be understood that they do not preclude in advance the presence or addition possibility of one or more other features, numbers, steps, operations, components, parts, or combinations thereof.

Unless otherwise defined, all terms used herein, including technical or scientific terms, have the same meaning as commonly understood by a person having ordinary skill in the technical field to which the present invention belongs. Terms such as those defined in commonly used dictionaries should be interpreted as having meanings consistent with the meanings they have in the context of the related art, and are not interpreted in an idealized or overly formal sense unless clearly defined in this specification.

Hereinafter, embodiments of the present invention will be described in detail with reference to the drawings attached to this specification. However, the scope of the patent application is not limited or restricted by these embodiments. The same reference numerals presented in each drawing indicate the same members.

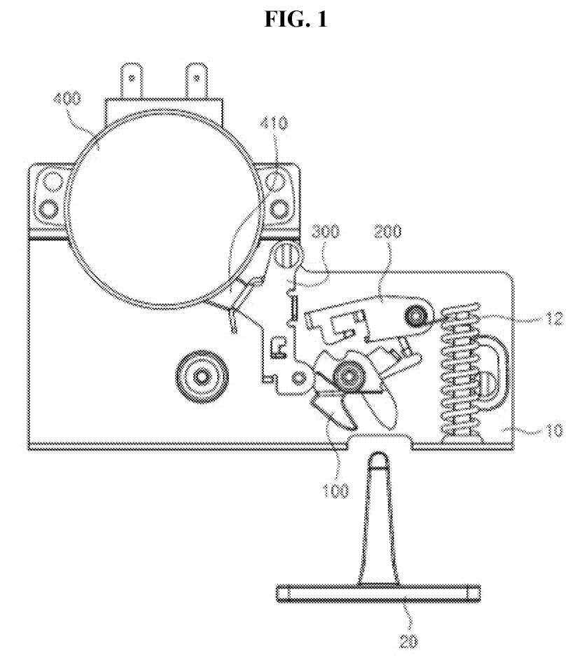

FIG. 1 is an internal plan view of a push door lock device according to an embodiment of the present invention.

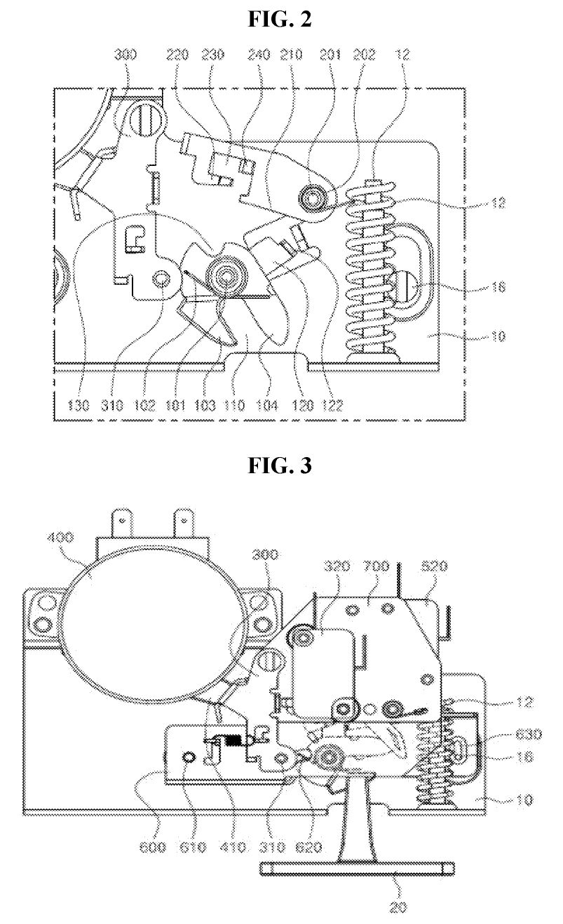

FIG. 2 is an enlarged internal view of a push door lock device according to an embodiment of the present invention.

As shown in FIGS. 1 and 2, the push door lock device according to an embodiment of the present invention includes a locker 100 that fixes a hook 20, has a first torsion spring 102 installed at a first center 101 and receives a rotational force in a first direction, and a latch 200 that rotates about a second center 201 attached to one side, has a second torsion spring 202 installed and receives a rotational force in a second direction.

In FIGS. 1 and 2, the first direction may mean clockwise rotation and the second direction may mean counterclockwise rotation, but is not necessarily limited thereto.

The push door lock device shown in FIGS. 1 and 2 may be formed by directly or indirectly attaching internal components to a base 10.

The base 10, locker 100, and latch 200 constituting the push door lock device according to an embodiment of the present invention may be made of hard metal material, but are not necessarily limited thereto and may be made of hard plastic material.

In addition, it is preferable that the material is resistant to heat depending on the function of the home appliance in which the door lock device is installed.

The locker 100 according to an embodiment of the present invention continuously receives rotational force in the clockwise direction by the first torsion spring 102. When the hook 20 flows into the locker 100, the locker 100 is forced to rotate in the counterclockwise direction, which is opposite to the rotational force in the clockwise direction. Of course, it is expected that the locker 100 will rotate counterclockwise as the hook 20 flows in with an external force stronger than the rotational force of the first torsion spring 102.

More specifically, the locker 100 includes a seating portion 110 formed by a first ring 103 and a second ring 104, an engaging portion 120 protruding from a lower portion of the second ring 104, an engaging piece 122 having a bent shape at one end of the engaging portion 120, and a groove portion 130 having a recessed shape on an outer edge.

The seating portion 110 is a portion to which the hook 20 flows in and is fastened. Although it is formed in a U-shape in FIGS. 1 and 2, there is no limitation on the shape, and it can be implemented in various forms to which the hook 20 flowing in from the outside can be fastened.

It is preferable that the first ring 103 and the second ring 104 are formed integrally. When forming the seating portion 110, the lengths of the first ring 103 and the second ring 104 may be different from each other.

The locker 100 according to an embodiment of the present invention includes an engaging portion 120. The engaging portion 120 is formed to protrude from the lower portion of the second ring 104. It is preferable that the engaging portion 120 is manufactured integrally with the first ring 103 and the second ring 104 so that it can rotate simultaneously with the rotation of the first ring 103 and the second ring 104.

In addition, as shown in FIGS. 1 and 2, an engaging piece 122 having a bent shape is formed at one end of the engaging portion 120. The engaging piece 122 is located at an edge of the engaging portion 120 and has a shape bent in a direction opposite to the base 10.

It is preferable that the engaging piece 122 is manufactured integrally with the engaging portion 120 in a solid and firm manner as a region that controls the movement of the locker 100 by the latch 200.

Furthermore, a groove portion 130 having a recessed shape is formed on an outer edge of the locker 100. As shown in FIGS. 1 and 2, the groove portion 130 may be formed in a recessed shape to a predetermined depth on an outer periphery at a point where the first ring 103 and the second ring 104 meet, but is not necessarily limited thereto.

The latch 200 according to an embodiment of the present invention continuously receives a rotational force in a direction opposite to the first direction, which is the rotational direction of the locker 100, and the cause is the second torsion spring 202 attached to one end of the latch 200.

As shown in FIGS. 1 and 2, the latch 200 according to an embodiment of the present invention includes a first inclined surface 210 that is an edge formed toward the locker 100, a second inclined surface 220 that is an edge formed toward the locker 100 and separated from the first inclined surface 210 at a different height, a receiving portion 230 in which the engaging piece 122 is accommodated to fix the locker 100, and a protruding piece 240 having a bent shape at one edge of the receiving portion 230.

The first inclined surface 210 formed on the latch 200 is formed toward the locker 100. More specifically, the edge of the latch 200 on which the engaging piece 122 rides and moves by the rotation of the locker 100 is the first inclined surface 210.

The second inclined surface 220 is an edge formed toward the locker 100 like the first inclined surface 210, and more specifically, is an inclined surface on which the engaging piece 122 is seated by the rotation of the locker 100, similar to the first inclined surface 210. The second inclined surface 220 is separated from the first inclined surface 210, and the height at which the first inclined surface 210 is formed and the height at which the second inclined surface 220 is formed are different from each other. Furthermore, as shown in FIGS. 1 and 2, the height at which the second inclined surface 220 is formed is designed to be lower than the height at which the first inclined surface 210 is formed.

The latch 200 according to an embodiment of the present invention includes a receiving portion 230, which is a space opened in a hook shape, with only an edge region consisting of the first inclined surface 210 and the second inclined surface 220 being opened.

As shown in FIGS. 1 and 2, the receiving portion 230 is a space in which the engaging piece 122 is accommodated to fix the locker 100. The engaging piece 122 moves in the receiving portion 230, allowing the latch 200 to engage with or separate from the locker 100. A more detailed description will be provided later.

The latch 200 according to an embodiment of the present invention includes a protruding piece 240 having a bent shape at one edge of the receiving portion 230. As shown in FIGS. 1 and 2, the protruding piece 240 has a shape obliquely bent toward the opposite side of the base 10. That is, the protruding piece 240 has a bent shape as if a slope is formed with respect to an imaginary surface of the latch 200 formed by the receiving portion 230.

Each configuration of the latch 200 may refer to a detailed configuration portion of the latch 200 formed integrally.

FIG. 3 is a plan view of a push door lock device according to an embodiment of the present invention.

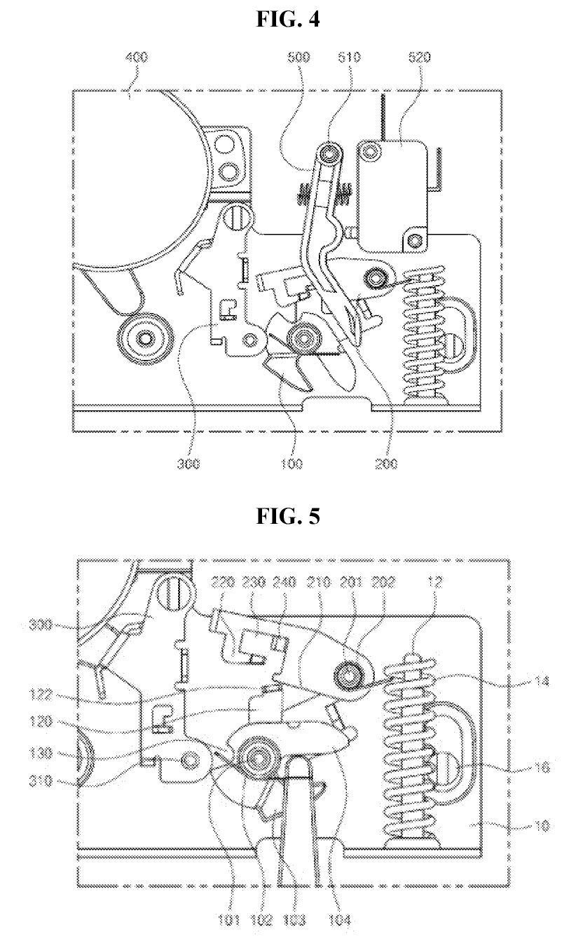

FIG. 4 is an internal plan view of a push door lock device according to an embodiment of the present invention.

The push door lock device according to an embodiment of the present invention includes a locking lever 300 provided with a locking flange 310 that rotates by a motor 400 and engages with the groove portion 130.

As shown in FIGS. 1 and 2, the locking lever 300 has one end rotatably coupled to the base 10, and is pushed and rotated by a motor arm 410 so that the locking flange 310 moves toward the locker 100, and the locking flange 310 engages with the groove portion 130 to prevent the locker 100 from rotating.

In addition, as the locking lever 300 rotates, it can press the first micro switch 320 as shown in FIG. 3 to confirm that the locker 100 is in a locked state.

As shown in FIG. 4, the push door lock device according to an embodiment of the present invention further includes a locker lever 500 having one end in contact with the second ring 104 and rotating, and a second micro switch 520 that detects a closed state of the locker 100 by movement of the locker lever 500.

The locker lever 500 rotates about a third center 510 coupled to the base 10 to press the second micro switch 520. Through this, it can be confirmed that the locker 100 is in a closed state or an open state.

That is, summarizing through FIGS. 3 and 4, when the locking lever 300 operates, it activates the first micro switch 320 and enables the locker 100 to externally display that it is in a locked state, and when the locker lever 500 operates, it activates the second micro switch 520 and enables external display that the locker 100 is in a closed state.

In particular, in the case of ovens, a heating and cleaning process is periodically performed to heat oil adhering to the oven to a temperature of 300 degrees or higher and blow it into the air, and some ovens must automatically maintain a locked state so that the oven door does not open during this process. At this time, as shown in FIGS. 2 and 3, the motor 400 rotates and the motor arm 410 pushes the locking lever 300 so that the locking flange is inserted into the groove portion 130 of the locker 100, and simultaneously presses the first micro switch 320 to confirm that the locker 100 is locked.

As shown in FIG. 3, the push door lock device according to an embodiment of the present invention includes a housing bracket 600 and a separate bracket 700.

The housing bracket 600 has a space formed therein in which the locker 100 and the latch 200 are mounted, and is connected to the base 10, a fourth center 610, and a fixing member 16. In addition, one end of a spring 14 coupled to an outer circumferential surface of a fixing rod 12 fixed to the base 10 is coupled to an upper portion of one side of the housing bracket 600, and a fixing member 16 formed nearby engages with a housing track 630 formed in the housing bracket 600 so that the housing bracket 600 can rotate at a predetermined angle along the housing track 630 about the fourth center 610.

A flange track 620 through which the aforementioned locking flange can move is formed on a side surface of the housing bracket 600.

The push door lock device has a problem in that the door cannot be opened if a malfunction occurs while the door is closed. In this case, when the door is pulled with a relatively strong force, the locker 100 is pulled by the hook 20, and the locker 100 is caught by an engaging protrusion formed in the housing bracket 600.

When the door is pulled by applying additional external force, the housing bracket 600 rotates about the fourth center 610. When pulled with a strong force that can overcome the elastic force of the spring 14 on the opposite side of the fourth center 610, the fixing member 16 rises along the housing track 630, causing the locker 100 to rotate, and the hook 20 is released from the first ring 103 of the locker 100.

That is, by configuring the housing bracket 600 as in the embodiment of the present invention, the locker 100 and the hook 20 can be separated in an emergency.

A separate bracket 700 is attached to an upper portion of the housing bracket 600. The separate bracket 700 performs a function of spatially separating the first micro switch 320 and the second micro switch 520. In addition, the locking lever 300 that operates the first micro switch 320 and the locker lever 500 that operates the second micro switch 520 are also spatially separated by the separate bracket 700. Through the separate bracket 700, a door lock device with a stacked structure can be implemented, enabling a structurally compact implementation.

The configuration of the push door lock device according to an embodiment of the present invention has been described above. Hereinafter, the closing process to the opening process through pushing of the push door lock device according to an embodiment of the present invention will be described through FIGS. 5 to 10.

FIG. 5 is a state diagram at a point in time when the hook 20 is fastened to the seating portion 110.

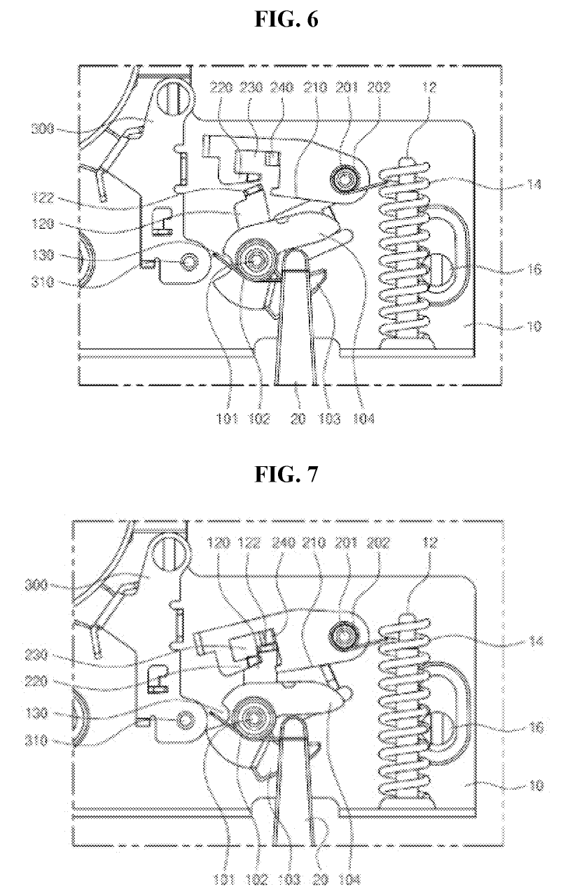

FIG. 6 is a state diagram at a point in time when the hook 20 pushes the second ring 104.

FIG. 7 is a state diagram when the locker 100 is closed.

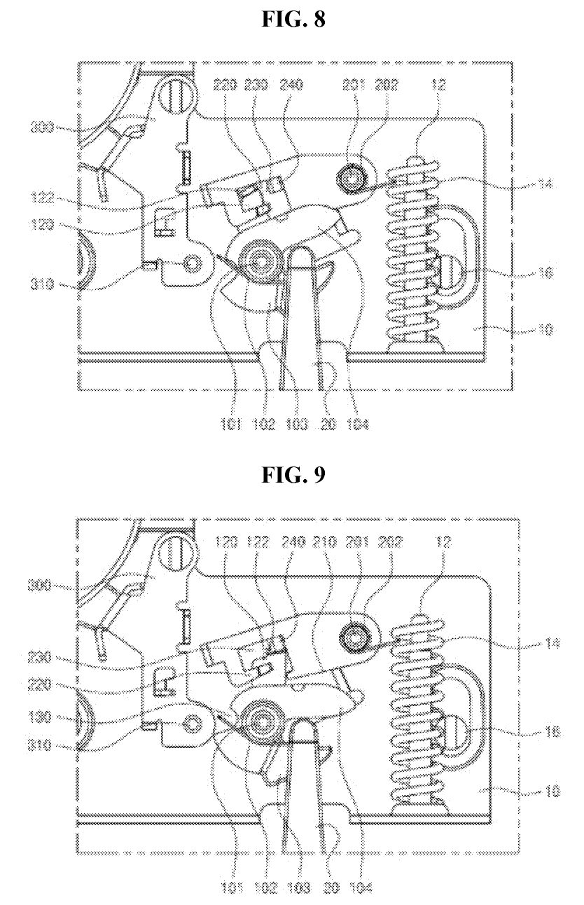

FIG. 8 is a state diagram when closing of the locker 100 is completed.

FIG. 9 is a state diagram when the locker 100 starts to separate from the latch 200.

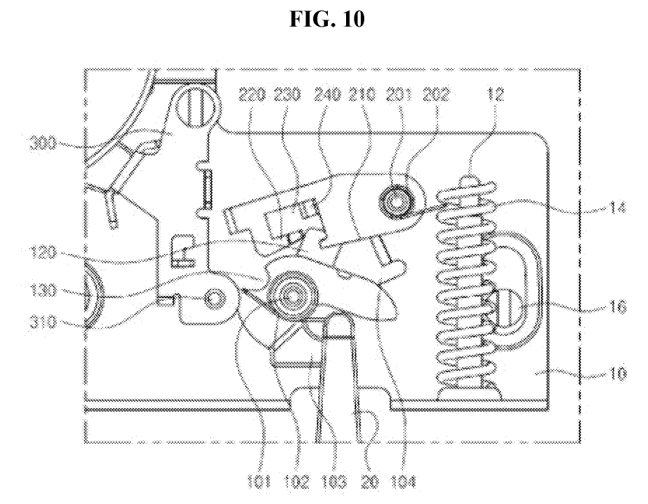

FIG. 10 is a state diagram when separation of the locker 100 and the latch 200 is completed.

As shown in FIG. 5, until the moment when the hook 20 is caught by the seating portion 110 of the locker 100, the hook 20 pushes and rotates the locker 100 in the counterclockwise direction. As the engaging portion 120 of the locker 100 rotates together, the engaging piece 122 of the engaging portion contacts the first inclined surface 210 of the latch 200 and rotates the latch 200 in the clockwise direction.

As shown in FIG. 6, when the hook 20 further pushes the second ring 104, the engaging piece 122 moves to the second inclined surface 220, and the latch 200 moves in the counterclockwise direction by the second torsion spring 202. The locker 100 continuously receives elastic force in the clockwise direction by the first torsion spring 102. When the locker 100 rotates in the clockwise direction while the second inclined surface 220 and the engaging piece 122 are in contact as shown in FIG. 6, the engaging piece 122 flows into a space of the receiving portion 230 formed in the latch 200.

As shown in FIG. 7, when the engaging piece 122 of the locker 100 flows into the receiving portion 230, the engaging piece 122 is seated on the protruding piece 240 of the latch 200.

According to FIG. 7, the hook 20 is in a process of being caught by the locker 100 and closing. By the rotational force in the first direction of the locker 100 and the rotational force in the second direction of the latch 200, as shown in FIG. 8, the engaging piece 122 is seated in the receiving portion 230 of the latch 200, and the door is in a closed state.

When the door is pushed in the closed state, the hook 20 pushes the second ring 104, and as shown in FIG. 9, the engaging piece 122 slides on the protruding piece 240 having an obliquely bent shape, and the engaging piece 122 comes out from behind the latch 200.

When separation of the locker 100 and the latch 200 is completed, as shown in FIG. 10, the locker 100 rotates to an open state, and the hook 20 is released from the seating portion 110 of the locker 100, causing the door to open.

The push door lock device according to an embodiment of the present invention can be opened by pushing using a mechanical shape and rotational force by a torsion spring.

Although the present invention has been described with reference to the embodiments shown in the drawings, this is merely exemplary, and those having ordinary skill in the art will understand that various modifications and equivalent other embodiments are possible therefrom. For example, even if the described techniques are performed in a different order than the described method, and/or components of the described systems, structures, devices, circuits, etc. are combined or combined in a different form than the described method, or are replaced or substituted by other components or equivalents, appropriate results can be achieved. Therefore, the true technical protection scope of the present invention should be determined by the technical spirit of the appended claims.

What is claimed is:

1. A push door lock device, comprising:
a locker that fixes a hook, has a first torsion spring installed at a first center, and receives a rotational force in a first direction; and
a latch that rotates about a second center attached to one side, has a second torsion spring installed, and receives a rotational force in a second direction,
wherein the locker includes:
a seating portion formed by a first ring and a second ring to which the hook is fastened;
an engaging portion protruding from a lower portion of the second ring;
an engaging piece having a bent shape at one end of the engaging portion; and
a groove portion having a recessed shape on an outer edge,
wherein the latch includes:
a first inclined surface that is an edge formed toward the locker;
a second inclined surface that is an edge formed toward the locker and separated from the first inclined surface at a different height;
a receiving portion in which the engaging piece is accommodated to fix the locker; and
a protruding piece having a shape obliquely bent at one edge of the receiving portion.

2. The door lock device of claim 1, further comprising
a locking lever provided with a locking flange that rotates by a motor and engages with the groove portion.

3. The door lock device of claim 2, further comprising
a first micro switch that detects an operation of the locking lever.

4. The door lock device of claim 1, further comprising:
a locker lever having one end in contact with the second ring and rotating; and
a second micro switch that detects a closed state of the locker by movement of the locker lever.
